(19) United States
(12) Patent Application Publication
(10) Pub. No.: US 2024/0252283 A1
(43) Pub. Date: Aug. 1, 2024

(54) Retainer for an Orthodontic Treatment and Method for Producing a Retainer of this Type

(71) Applicant: René Cyron, Friedrichsdorf (DE)

(72) Inventor: René Cyron, Friedrichsdorf (DE)

(21) Appl. No.: 18/290,176

(22) PCT Filed: May 18, 2022
(86) PCT No.: PCT/DE2022/100374

§ 371 Date: Nov. 10, 2023

(30) Foreign Application Priority Data
May 18, 2021 (DE) 10 2021 112 795.5

(51) Int. Cl. A61C 7/08; A61C 7/00; B33Y 80/00

(52) U.S. Cl. CPC A61C 7/08; A61C 7/002; B33Y 80/00

(57) ABSTRACT

A retainer for orthodontic treatment comprises one or more double wings, each double wings consisting of a center piece and two wings adjoining the center piece laterally, the wings are formed areally and each have a front side and a rear side, the front side being formed for surface bonding to the lateral surface of a tooth and the center piece firmly connecting the wings adjoining it to one another. The retainer allows for individualized adaptation without detaching the entire retainer for bonding renewal or in case of damage or loss of a double wing. An electronic image of the tooth row contour is utilized for customized producing the retainer by using 3D printing or milling.

### TECHNICAL FIELD

The present disclosure relates to a retainer for orthodontic treatment.

### BACKGROUND

Retainers of this type are used after orthodontic therapy to stabilize the newly positioned teeth. The retainer is bonded to the intraoral side of the teeth in the anterior region.

Retainers usually feature either a spring hard twisted steel wire, a TMA (titanium-molybdenum-alloy) wire or a nickel-titanium alloy wire. Both twisted steel wires and nickel-titanium alloy wires have a high restoring ability. Such a retainer is described, for example, in EP 3 563 793 A1. It connects several teeth together. This has the disadvantage that it may have to be completely removed or complicated repair work may be required if only the adhesion to a single tooth has loosened or if it is broken/damaged.

Another disadvantage of known one-piece retainers is the fact that the material used must be removed from all teeth when the retainer is removed. For example, a drill designed for metal can cause sensitive tooth damage with every removal of material and may even irretrievably destroy teeth. If the retainer is damaged or broken in only one area, for example, or if only the area of one tooth or a few teeth is to be reworked or modified, the retainer does not have to be completely removed but can be repaired or partially modified. In this partial repair, the defective retainer piece is cut out and replaced.

EP 2 263 597 A2 describes a retainer consisting of several individual retainers, each of which consists of two magnetically connected modules. The modules are each glued to one of the two adjacent teeth. The mutual support of the teeth is mediated by the magnetic retention force between the modules. However, this force is not always sufficient to achieve the necessary stabilization. In other words, in numerous cases the clinical goal of treatment with such a retainer cannot be achieved.

### General Description

The present disclosure provides a retainer that sufficiently stabilizes the teeth and at the same time enables easier repair if only individual adhesive points should have come loose or the retainer or metal should be broken.

The present disclosure relates to a retainer, usually consisting of several single or possibly contiguous double wings. Each double wing consists of a center piece and two laterally adjacent wings, which are shaped for surface bonding to the lateral surface of a tooth. The center piece is placed approximately halfway up the tooth crown between two teeth, where it is inserted as far and as pointedly as possible into the gap between the teeth. The two wings follow the gingival margin and end approximately in the sagittal plane of a tooth.

To produce a retainer, an electronic image of the intraoral side of a tooth row contour is taken and used to produce, for example by means of a 3D printer or a 3D milling machine, an individually adapted retainer, thus, for example, by printing or milling.

If the bonding of a double wing becomes loose over time, its bonding can be renewed without having to detach the entire retainer from the teeth. If a double wing is damaged or lost, the function of the retainer is essentially maintained even on the affected tooth.

The present disclosure provides,
that the retainer consists of one or more double wings, each double wing consisting of a center piece and two wings laterally adjoining it,
that the wings are formed flat and each have a front side and a rear side, the front side being formed for surface bonding to the lateral surface of a tooth, and
that the center piece firmly connects the two wings.

In one example, the center piece and both wings form a recess which, follows the shape of the gingival margin. For example, a lambda-shaped recess is formed in the area of the center piece, cf. FIG. 2. For example, an arch can be formed by the retainer both in the lateral view and in the axial view, the zenith of which is formed by the center piece, cf. FIG. 1.

Each of the double wings is placed between two adjacent teeth, with the center piece lying in the gap between the teeth and the wings resting with their front sides against the flanks of the teeth, where they are glued to them. The arch shape of the axial view thus corresponds to the cross section of two adjacent teeth, with the zenith of the arch corresponding to the gap between the two teeth and the wings following the intraoral contour of the teeth.

Two double wings are attached to each non-marginal tooth that is to be spanned by the retainer. This means that two double wings are attached, for example glued, to a non-marginal tooth, for example on its rear tooth flank. Thus, a first double wing attached there can connect this non-marginal tooth with its left neighbor and a second double wing attached there can connect this non-marginal tooth with its right neighbor. Typically, each marginal tooth that marks a respective end piece of the area spanned by the retainer is fitted with one double wing only, because only one double wing is attached there, which is connected to only one neighboring tooth of the marginal tooth. A double wing to be attached to a marginal tooth may differ in that the entire tooth flank on the marginal tooth can be used for the abutment of the single double wing, since the abutment surface does not have to be shared with a second double wing to be attached there.

In one example, the retainer may span the range from a first canine tooth through the incisors to a second canine tooth of a jaw. In this example, the canines are the marginal teeth, each of which has only one double wing associated with it, and the incisors are the non-marginal teeth, each of which has two double wings associated with it.

Due to the arch shape related to the lateral view, the center piece can be placed approximately halfway up the tooth crown, with the wings following the gingival margin to the lower end of the tooth up to its sagittal plane. This provides a support for the retainer close to the base of the tooth, which promotes a defined stabilization of the teeth. The retainer is thus located close to the center of resistance of the tooth.

The double wings are glued to the tooth flanks face to face and hold the teeth in position by supporting each other with the double wings. The adhesion on faces makes it more difficult for the teeth to tilt relative to each other, which significantly improves stabilization.

In other words, each double wing is bonded flat to one tooth flank of two adjacent teeth. A double wing thus provides a glue-locked connection from the tooth flank of a first tooth through the body of the double wing to the tooth flank of a second tooth arranged adjacent to the first tooth. Preferably, the glue-locked connection is limited to the spatial extent of the two adjacent teeth. This has the further desirable result that in case an adhesive bond is lost, only one double wing is affected and the second double wing, which is attached to the same tooth, can still stabilize the affected tooth. In other words, the wing adjacent to the defective wing continues to stabilize the affected tooth. Therefore, since each non-marginal tooth typically has more than one adhesive bond, a redundancy is created that is capable of continuing to maintain the function or effect of the retainer in the event of a defect. It is possible that the effect may be less or limited compared to a fully functional retainer without a defect, but the affected tooth does not completely fall out of the retainer bond. This is therefore in contrast to one-piece retainers, where the defect of an adhesive bond simultaneously means the loss of the tooth from the retainer bond and the affected tooth can shift, for example in relation to the other teeth of the retainer bond.

Furthermore, two double wings are preferably attached to a tooth flank of a non-edged tooth, so that a first double wing creates a glue-locked connection from a left-adjacent tooth to the tooth and a second double wing creates a glue-locked connection from a right-adjacent tooth to the tooth. In contrast, no frictional connection is provided from the first double wing to the second double wing, or a frictional connection is deliberately avoided or broken through. Such a continuous force-locked connection from a first double wing to the second double wing is not necessary, since the adhesive bond connects the two double wings sufficiently firmly to the tooth and a flux of force can thus be guided via the adhesive bonds and the tooth itself. Omitting the force-locked continuous connection between the double wings is therefore desirable to the stabilization of the teeth.

To achieve even better stabilization, the wings can be widened towards their free ends.

The free ends of the wings are separated from each other. This enables the intended easy repair of individual double wings.

To simplify production, however, a chain-like structure would also be conceivable, with the free ends of the wings of two adjacent double wings being connected to each other in a separable manner, for example. Here it may be necessary, when replacing a double wing, to first separate its connection to the adjacent double wings. The double wing separated out can then be glued again without reconnecting it to the adjacent double wings, since each individual double wing is capable of stabilizing the teeth connected to it on its own.

In addition to the adhesion of the individual double wings, a clasp may be provided which is supported on a plurality of double wings. For this purpose, the present disclosure provides means on the rear side of the double wings to fix a clasp connecting several double wings.

The double wings are made of metal or a metal alloy to achieve the required stability. However, other materials can also be used for the manufacture of the retainer according to the present disclosure, as has been found out in a convincing manner. In addition to various plastics and plastic-ceramic composites, experience has also been gained with the material polyetheretherketone (PEEK), which has very good properties for the manufacture of the retainer according to the present disclosure. It may be desirable if the material is easy to glue and provides inert flexibility so that the smallest dynamic changes in tooth position can be tolerated. In this case, PEEK, in addition to a resin-ceramic mixture, has proven to be very suitable. PEEK is also available in various colors such as tooth white. The aforementioned materials can be used in additive manufacturing (3D printing) or in a milling process to provide the retainer according to the present disclosure.

Materials such as plastic-ceramic mixtures or PEEK offer the further desirable result that in the event of removal of possible material residues of the retainer—which in the case of the present description would only have to be carried out on two teeth, for example—it is also possible to work with a drill for plastics, since no metal has to be removed. A drill designed for plastics damages the tooth surfaces considerably less than a drill for metals or metal alloys, so that not only are fewer teeth damaged, but these teeth themselves would also be less damaged if there were a loss of adhesion of a retainer piece or the like.

To produce a retainer, an electronic image of the intraoral side of a tooth row contour is taken and used to produce, for example by means of a 3D printer or a 3D milling machine, an individually adapted retainer, thus, for example, by printing or milling.

The retainers are desirable to be manufactured using a 3D process, such as 3D printing or 3D milling. To this end, the present disclosure can provide that an electronic 3D image of the intraoral contour of the teeth to be supported is generated, that a printing or milling template for a 3D printer or a 3D milling machine is calculated from the 3D image, for example, and/or that the retainer is produced, for example by means of a 3D printer or a 3D milling machine using the calculated printing or milling template.

The benefit of this approach is that only an electronic 3D image needs to be created in the individual dental practices, which can then be sent to a central office that has manufacturing equipment such as a 3D printer or a 3D milling machine to produce a customized retainer from the electronic 3D image.

The electronic image can be generated by scanning the teeth themselves. However, it is also conceivable that a dental impression is created first and the scan is performed on a model created from it.

The double wings of the retainer can be manufactured individually. However, it would also be conceivable to manufacture them as a double wing composite, at least as part of a retainer manufacturing process, i.e., initially in a single chain-like structure, for example, in one piece. In this case, the double wings of the retainer are designed to be separable from one another in order to realize the desirable results of the present disclosure. For example, the separability of the double wings leads to a changed geometry and shape of the retainer and with regard to a changed flux of force through the retainer. Following the retainer manufacturing process, the double wings can be separated from each other, should this appear necessary; however, such a releasable bond of the double wings to each other, in the manner of a predetermined breaking point, can also be maintained in an insertion position of the retainer in the oral cavity of a user, if necessary. This can simplify the insertion of the retainer without impairing the special functionality of the multi-part retainer.

In other words, each of the double wings is thus a separate and distinct component from the other double wings. This does not exclude the possibility that a double wing of the retainer can be temporarily, i.e., separably or detachably, connected to adjacent double wings, so that the connection between two retainers can be detached in a simple manner, for example at a predefined or prepared point, without impairing the function and supporting force of the double wings. Also, the pre-fitting with a detachable, pre-constructed connection point (predetermined breaking point) enables the separation of a double wing from a compound of double wings in case of replacement or repair of this double wing without affecting the neighboring double wings and without affecting the overall support function of the retainer. As an example, the special functionality of the multi-piece retainer allows all teeth of the retainer composite to still be supported even if the retainer is damaged or broken in one place, or even in several places. A one-piece retainer is not able to do this, and this function remains available regardless of whether the retainer is initially fabricated as a detachable composite of double wings or is inserted into the oral cavity. This also distinguishes an initially chain-like connected form of the multi-part retainer from a one-piece retainer of known design.

In a simple example, the transitions between two double wings could be made thinner, resulting in a kind of predetermined breaking point. This facilitates the separation of a single double wing from an applicated retainer when the latter has to be replaced or newly bonded.

In an insertion position of the retainer such as the oral cavity of a patient, each double wing acts as an independent, separate component of the retainer, irrespective of whether a double wing is temporarily or detachably connected to the neighboring double wing or whether the individual double wings are already inserted as separate components in the insertion position from the start. Even if the individual double wings are therefore separably or detachably connected to each other in the insertion position, each double wing acts as a separate component of a plurality of components separated in this way, so that the retainer is to be regarded as a multi-part element and, for example, no force-locked connection of a double wing is maintained through the detachably designed connection to the adjacent double wing. Rather, the connection between a double wing and the adjacent double wing is deliberately designed to be detachable or separable, so that the retainer as an overall product in the insertion position is not a one-piece design that also transmits forces, for example via a substance-to-substance bond, but rather the design has the aforementioned and subsequent design differences compared to a one-piece design, precisely in order to enable a double wing to be separated from the retainer in the insertion position.

A single replacement of a double wing can also be desirable if the force application is to be adapted to individual tooth areas, but the remaining jaw area is not to be affected. In this case, compared to a continuous retainer that only a local change of the flux of flow, namely limited to even only one or two teeth, can be made without changing the remaining teeth. This is not possible with a continuous, one-piece retainer, since the entire retainer always has to be replaced and the entire jaw always has to be checked and adjusted when the retainer is readjusted. In other words, the present disclosure also enables local, i.e., spatially limited, changes in the application of force or support to the teeth held by a double wing without having to realign the entire retainer composite.

Another desirable result of the retainer in the present disclosure is that it can be manufactured very thinly, for example so thinly that there is no or hardly any interference with the range of movement of the opposite jaw. This can be achieved by various further developments of the retainer presented here, for example by shaping the wings, each of which provides a large tooth adhesive area, and shaping the center piece, which protrudes into the interdental space and can therefore safely be made thicker than the wings without entering the movement space of the opposite jaw:

For example, the retainer can have a thickness of 0.75 mm or less, preferably 0.5 mm or less, more preferably 0.3 mm or less, or even only 0.2 mm or less in the area of the wings. Here, depending on the material, it is preferred to provide a minimum thickness of 0.1 mm or more, preferably 0.15 mm or more, or even 0.25 mm or more in the area of the wings to avoid tearing or damage when inserting the retainer. The center piece can then protrude, for example in a wedge shape, into the interdental space and have a thickness of, for example, around 1 mm+0.3 mm. In a preferred embodiment, the center piece can also have a thickness of around 0.5 mm+0.3 mm.

In some orthodontic treatment cases, a “deep bite” is present, which can sometimes be associated with a high probability of recurrence. In order to prevent this recurrence of the deep bite, possibly even in addition to a different type of tooth displacement such as a rotation of the teeth, it is a possibility to provide a bite block presented hereafter. Such a bite block can be designed in combination with the embodiments shown in the present disclosure.

The provision of a bite block can prevent displacement of the teeth. For example, elongation of the anterior teeth can be prevented by supporting the mandibular anterior and/or posterior teeth on one or more of the bite blocks. Finally, such a bite block or bite elevation can also be used for a therapeutically desired bite elevation.

For the provision of a bite block, a support side is provided for the placement of the opposing teeth. If the retainer is to be arranged on the backs of the teeth, the bite block is arranged on a retainer of the upper jaw, since the teeth of the lower jaw come to rest on the backs of the teeth of the upper jaw and the bite block can be provided there in a simple manner.

A double wing according to the present disclosure can comprise at least one, preferably two, bite blocks. For example, two bite blocks can be provided on each non-marginal tooth, and one bite block can be provided on a marginal tooth. The bite blocks can be designed in such a way that the two bite blocks arranged together on one tooth flank present themselves as a common bite block in functional or optical terms. Any gap between the joint bite block, i.e., between the two “half bite blocks” arranged on one tooth flank, proves to be safe from a functional point of view.

In the following, the present disclosure will be explained in more detail by means of embodiment examples and with reference to the figures. Here, similar or identical elements have partly the same reference signs, and the features of the various embodiment examples can be combined with each other.

### BRIEF DESCRIPTION OF THE DRAWINGS

In the drawings:

FIG. 1 is a top view of a jaw section with inserted retainer,

FIG. 2 is a computer-simulated representation of a retainer according to the present disclosure,

FIG. 3 is an embodiment of a retainer with bite blocks,

FIG. 3A provides a side view of an incisor with attached retainer with bite block,

FIG. 3B provides another view of a tooth with attached retainer with bite block.

### DETAILED DESCRIPTION

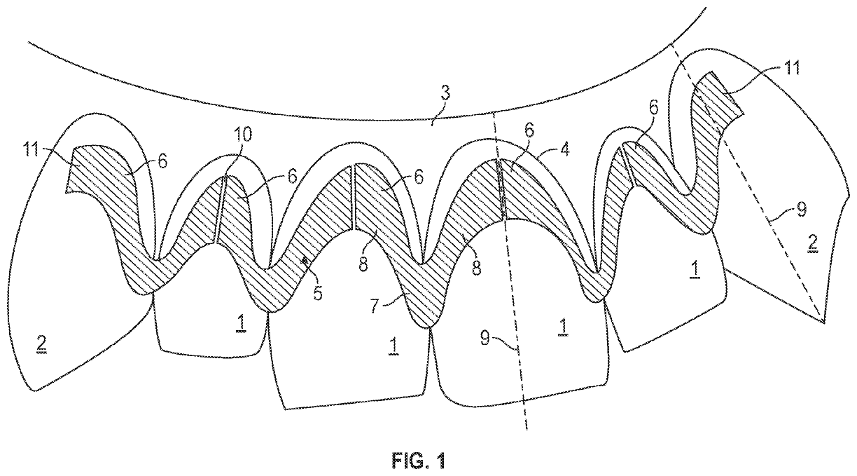

FIG. 1 shows a lateral view, i.e., the intraoral side of an upper incisor row to which a retainer according to the present disclosure is attached.

Four incisors 1 and two canines 2 are shown in lateral view. These protrude from the gingiva 3, whereby the course of the gingival margin 4 runs along the tooth in the form of a cycloid, the tips of which point upward.

The retainer 5 consists of several double wings 6, each consisting of a center piece 7 with two wings 8 projecting from it. Two double wings 6 are assigned to each non-marginal incisor 1, and one double wing 6 is assigned to each of the marginal canines 2.

As can be seen from the lateral view of the double wings 6 shown in FIG. 1, they each form a lambda-shaped arc in a vertical plane, with the center piece 7 forming the zenith of the arc and the wings 8 forming its downward sloping end sections.

According to an axial view (view from above on the tooth) of the double wings, which is not shown, these also have a lambda-shaped arcuate form in a horizontal plane. This shape allows the center piece 7 to be placed approximately halfway up the tooth crown between two incisors 1, 1 or an incisor and a cuspid 1, 2, where it can be inserted as far and as pointedly as possible into the gap between the respective teeth. The two wings 8 follow the gingival margin 4 and end approximately in the sagittal plane 9 (plane of a tooth transverse to the tooth row) of a tooth 1, 2.

The two wings 8 and the center piece 7 are glued to the teeth. For this purpose, the wings 8 are formed flat so that their front sides facing the teeth 1, 2 form a large adhesive area. In other words, one wing 8 is glued to each tooth 1, 2, so that a glue-locked connection is produced from a first tooth 2 via the wing 8 of the double wing 6 and via the other wing 8 to a second tooth 1. A substance-to-substance bond from a first double wing 6 into a second double wing 6 to realize a force-locked or form-locked connection has turned out to be unnecessary. Rather, the flux of force or the support of the jaw as a whole takes place via the tooth flanks themselves and not through a continuous retainer. With the present new design of a retainer 5, a detour of the flux of force through the tooth flanks is also realized, which contributes to the fact that it is possible to provide a separable retainer 5 of the type described here, in which individual components can be exchanged if necessary.

The adjacent ends of the wings 8 merge into one another or can be separated by a small gap 10. However, it would also be conceivable to connect the double wings 6 to each other and to design the connection with a predetermined breaking point.

The wing ends 11 of the double wings located on the outside in the retainer are elongated so that they extend beyond the sagittal plane 9 of the tooth and wrap around the tooth, in the embodiment example shown here, the two canines 2.

To manufacture a retainer, an electronic image of the intraoral side of the tooth row contour is taken and used to produce an individually adapted retainer by means of a 3D printer or a 3D milling machine, i.e., to print or mill it, for example. The retainer can then be attached to the back of the teeth either as a whole or broken down into double wings and then glued there. If the upper jaw is to hold a retainer, the row of teeth of the lower jaw is also scanned. In this way, possible tooth contact between the opposing teeth/antagonists and the retainer can be avoided.

If an adhesion becomes loose over time, the adhesion can be renewed without having to detach the entire retainer from the tooth row. If necessary, the affected double wing can be individually remade if it is damaged or lost and inserted into the retainer bond.

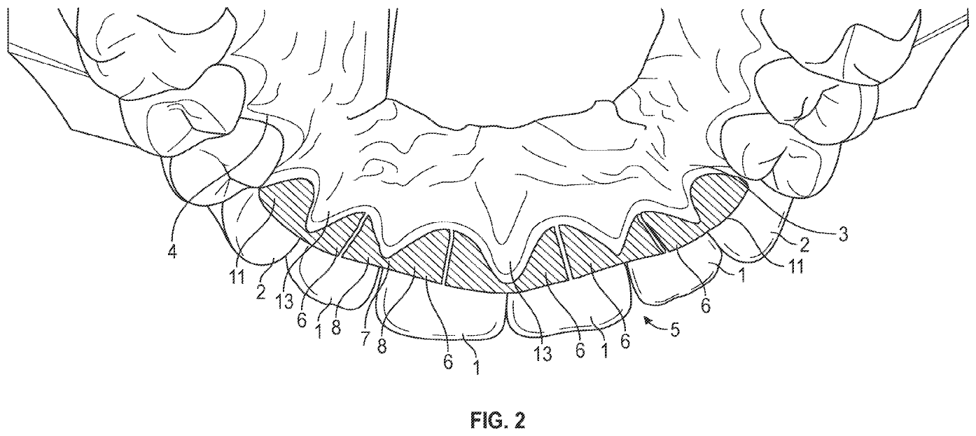

FIG. 2 shows a further illustration of a retainer 5 according to the present disclosure in the inserted position on a jaw, whereby the inner contour of the retainer 5 follows the course of the gingival margin 4. In contrast to the embodiment shown with FIG. 2, the wings 8 are enlarged so that they form an enlarged adhesive area on the tooth flank. The enlarged adhesive area can increase the bonding strength on the respective tooth. This may also enable a thinner structure of the retainer 5, which can thus be worn more comfortably, since the range of movement of the opposite jaw (not shown) is not impaired or only impaired to a lesser extent. The flatter design also allows for an easier dental hygiene, as less build-up space is required in which food debris could accumulate. The side of the wings 8 opposite the gingival margin 4 is shown as a straight cut line in this embodiment. To further increase the adhesive area of the wings, a further widening of the wings 8 in the direction of the tooth tips is also conceivable. Thus, the double wings 6 shown in FIG. 2 in the manner of a “half hourglass” could also form a “whole hourglass” by enlarging the wings 8 in an axis-mirrored manner.

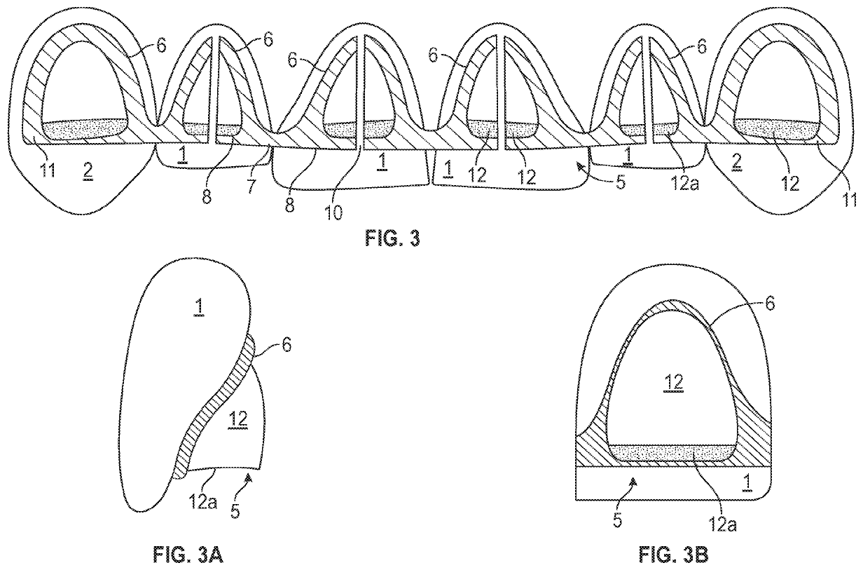

With reference to FIGS. 3, 3A and 3B, the design of the retainer 5 with bite block 12 is shown. FIG. 3 shows a schematic representation of a frontal jaw section with the four incisors and two canines and attached retainer 5, whereby the retainer 5 is constructed from a plurality of double wings 6, which are not connected to the respective adjacent double wing 6 and thus do not form a continuous or even one-piece retainer 5. Rather, in the form shown, the retainer 5 has a plurality of individual components in the form of the double wings 6. As in the previously described embodiment, each double wing 6 has a center piece 7 and two wings 8 each and is arranged in such a way that each double wing 6 connects two teeth 1, 2 with each other. By lining up the plurality of double wings 6, the teeth are thus successively connected to each other and thus the retaining effect is achieved as would be the case with a continuous retainer 5.

On each non-marginal tooth 1, here the incisors 1, a gap 10 is visible which clearly separates a left double wing from a right double wing. Should a single one of the plurality of double wings 5 become detached or need to be replaced for any other reason, this is easily possible without having to replace the entire retainer.

The retainer 5 provides a bite elevation by equipping each double wing 6 with two bite blocks 12. The teeth of the opposite jaw (not shown) can come into contact with the contact surfaces 12a on the bite blocks 12, so that the height of the bite can be adjusted by means of the retainer equipped with bite blocks 12. The bite blocks 12 are arranged in pairs on the respective tooth flanks, i.e., a first bite block 12 of a left double wing 5 and a second bite block 12 of a right double wing 5 are arranged on the same tooth flank and spaced apart from each other by the gap 10, for example.

The retainer 5 according to this embodiment can therefore provide the dual function of firstly providing support for the jaw or intervening therapeutically in the tooth position and secondly providing an adjustment of the bite height for the user. Nevertheless, this embodiment of the retainer 5 also allows replacement of a single double wing 6 at a time, so that in the event of failure of a double wing 6—or for any other purpose for which a double wing 6 would have to be replaced—a single double wing 6 can be removed or replaced without having to replace the entire retainer 5. If a section 6 of the retainer 5 is lost, all teeth 1, 2 are nevertheless still stabilized by the remaining double wings 6.

With reference to FIG. 3A, a side view of an incisor 1 with attached retainer 5 with bite block 12 is shown. The bite height can be adjusted by designing the contact surface 12a. With reference to FIG. 3B, a further illustration of a side surface of a tooth 1 is shown, in which the bite block 12 is shown continuously. Such a bite block 12 of the retainer 5 can, for example, nevertheless functionally consist of two individual parts, but be temporarily or detachably connected to each other in order to prevent food residues from entering the intermediate space 10. For example, the shape shown with FIG. 4 can already be created by placing the two double wings 6 attached to a tooth 1 so close together that the gap 10 becomes vanishingly small. This does not impair the additional inventive effect that a single double wing 6 can still be replaced as an individual part without having to replace the entire retainer 5.

It is apparent to those skilled in the art that the embodiments described above are to be understood as exemplary and that the present disclosure is not limited to these, but can be varied in a variety of ways without departing from the scope of protection of the claims. Furthermore, it is apparent that the features, whether disclosed in the description, the claims, the figures or otherwise, also individually define essential components of the present disclosure, even if they are described together with other features. In all figures, the same reference signs represent the same objects, so that descriptions of objects which may be mentioned in only one or in any case not with respect to all figures can also be transferred to these figures, with respect to which the object is not explicitly described in the description.

1. A retainer for orthodontic treatment, characterized in that it consists of one or more double wings, each double wing consisting of a center piece and two wings adjoining the center piece laterally, wherein the wings are formed areally and each have a front side and a rear side, the front side being formed for surface bonding to the lateral surface of a tooth and the center piece firmly connecting the wings adjoining it to one another.

2. The retainer according to claim 1, characterized in that the wings are made wider towards their free ends.

3. The retainer according to claim 1, characterized in that the free ends of the wings are separated from each other.

4. The retainer according to claim 1, characterized in that means on the rear side of the double wings for fastening a clasp connecting several double wings.

5. The retainer according to claim 1, characterized in that it is made of a metal, a metal alloy, a plastic-ceramic composite or polyetheretherketone (PEEK).

6. The retainer according to claim 1, characterized in
that the retainer in the region of the wings has a thickness of 0.75 mm or less, and/or
that the retainer in the area of the wings provides a minimum thickness of 0.1 mm or more.

7. The retainer according to claim 1, characterized in
that the center piece with both wings forms a recess which follows the shape of the gingival margin, and/or
that a lambda-shaped recess is formed in the region of the center piece, and/or
that an arc is formed by the retainer both in the lateral view and in the axial view, a zenith of which is formed by the center piece.

8. The retainer according to claim 1, characterized in
that the center piece projects into interdental space, or and/or
that the center piece has a thickness of around 1 mm±0.3 mm.

9. The retainer according to claim 1, characterized in that at least one bite block is included.

10. The retainer according to claim 1,
wherein the double wing comprises at least one bite block, or two bite blocks each, and/or
wherein the two bite blocks are provided on at least one of the teeth to be supported, which are separated.

11. The retainer according to claim 9, wherein the bite block are formed integrally with the double wing.

12. The retainer according to claim, wherein the bite block comprises a contact surface for bearing against a tooth of an opposing jaw.

13. A method for producing a retainer of claim 1, characterized in that an electronic 3D image of the intraoral contour of the teeth to be supported is generated, in that a printing or milling template for a 3D printer or a 3D milling machine is calculated from the 3D image, and the retainer is produced by means of the 3D printer or the 3D milling machine using the calculated printing or milling template.

14. The method according to claim 13, characterized in that double wings of the retainer are produced as a double wing composite in a retainer production process and are designed to be separable from one another.
